(19) United States
(12) Patent Application Publication
(10) Pub. No.: US 2012/0248023 A1
(43) Pub. Date: Oct. 4, 2012

(54) MEMBRANE FILTRATION MODULE

(75) Inventors: Jörg Zacharias, Koefering (DE); Dirk Scheu, Amerdingen (DE)

(73) Assignee: KRONES AG, Neutraubling (DE)

(21) Appl. No.: 13/433,328

(22) Filed: Mar. 29, 2012

(30) Foreign Application Priority Data
Mar. 31, 2011 (DE) 102011006543.1

(51) Int. Cl. B01D 35/02; B01D 35/30

(52) U.S. Cl. 210/236; 210/460

(57) ABSTRACT

A membrane filtration module including a membrane element for filtering a liquid, a discharge pipe for the permeate or filtrate, and a connection device for joining a conduit to the discharge pipe, where the surface shell of the discharge pipe along a first longitudinal part is surrounded by the membrane element, where in a second longitudinal part the discharge pipe protrudes over the membrane element, and where the connection device in the region of the second longitudinal part is joined to the discharge pipe.

### CROSS-REFERENCE TO RELATED APPLICATION

The present application claims the benefit of priority of German Application No. 102011006543.1, filed Mar. 31, 2011. The entire text of the priority application is incorporated herein by reference in its entirety.

### FIELD OF THE DISCLOSURE

The present disclosure relates to a membrane filtration module, in particular for a filtration system.

Membrane filtration modules are used, for example, in water treatment. Generally, these are ultra-filtration systems. Here, plastic membranes are used, the pore sizes of which lie in a range from approx. 1 μm to 0.001 μm. In some fields ceramic membranes are also used.

A frequent form of construction of membrane filtration modules comprises a central discharge pipe, which is surrounded by the membranes and through which the filtrate or permeate can be passed out of the membrane filtration module. Here, the membranes are usually arranged in a cartridge case to which they are joined using so-called potting. In the case of plastic membranes this is normally an epoxy potting with which the plastic membranes are permanently joined or cast to the cartridge case.

Particularly in the field of the beverage industry strict hygiene requirements have to be fulfilled. The field of application for membrane filtration modules extends from simple water disinfection through to the production of sterile water and beverages (e.g. cold aseptic beverage production). Known membrane filtration modules have a weak point here with regard to their capability for cleaning, disinfection and sanitation. Consequently, the use of membrane filtration modules in the beverage industry is often regarded critically.

Therefore, one aspect of the present disclosure is to provide a more hygienic membrane filtration module.

The disclosure provides a membrane filtration module, including:

a membrane element for filtering a liquid,

a discharge pipe for the filtrate or permeate, and

a connection device for joining a conduit to the discharge pipe,

where the surface shell of the discharge pipe along a first longitudinal part is surrounded by the membrane element,

where the discharge pipe in a second longitudinal part protrudes over the membrane element, and

where the connection device is connected to the discharge pipe in the region of the second longitudinal part.

Due to the fact that the connection between the connection device and the discharge pipe is arranged in the second longitudinal part, that is in a region in which the discharge pipe is not surrounded by the membrane element, the connection for an external conduit can be formed more hygienically. In particular, the connection region can be cleaned more simply and better.

The membrane element can comprise one or a plurality of hollow-fiber, plate or spiral-wound membranes. Plastic, for example polyethersulphone, ceramics, or a sintered metal, can be used as a material for the membrane.

The liquid to be filtered may in particular be a beverage, for example, water.

In particular the permeate or filtrate can here be taken to mean the filtered medium, that is the filtered liquid. The medium filtered off from the liquid can be designated as the retentate.

The membrane filtration module can be formed as a dead-end or cross-flow module.

The conduit, which is to be connected to the discharge pipe, can be for example a conduit of a filtration system, in particular wherein the permeate or filtrate can be passed via the conduit to a further element of the filtration system, for example a reservoir tank.

The discharge pipe can in particular run along the longitudinal or symmetrical axis of the membrane element. In other words the discharge pipe can be a central discharge pipe that is arranged in particular concentrically to the symmetrical axis.

The discharge pipe can be arranged such that the filtrate can be passed from the membrane element into the discharge pipe. For example, in the region of the first longitudinal part the discharge pipe can comprise one or a plurality of openings, in particular within an upper and/or lower potting or welding or bonding of the membranes.

The discharge pipe can be formed essentially cylindrically. The discharge pipe can therefore comprise a cylindrical surface shell and two oppositely situated ends or openings.

The length of the discharge pipe can be longer than the length of the membrane element. In the second longitudinal part the discharge pipe can in particular not be surrounded by the membrane element.

The connection device can be in particular a flange connection device. The connection between the second longitudinal part and the discharge pipe can therefore be in particular a flange connection. Thus, for example, in contrast to a plug connection, a more hygienic connection can be obtained.

The membrane filtration module can comprise in particular a wall, which surrounds the membrane element. The wall can in particular be formed cylindrically and can be arranged on the outer side of a cylindrically formed membrane element. The membrane element can be connected to the wall by potting, in particular casting. In the case of a plastic membrane element potting can be provided in particular by an epoxy resin. The membrane element can also be joined in a plurality of regions, for example in the end regions, by potting to the wall.

In the second longitudinal part the discharge pipe can in particular protrude over the potting, that is, not be surrounded by the potting.

The membrane filtration module, in particular the discharge pipe and the membrane element, can be made in particular from a material which can be sanitized by hot water. In particular the material can be formed such that hot water temperatures from 121° C. to 140° C. with temperature gradients of up to 4° C./min can be employed during sanitization or hygienization. Sterilization can in particular also be designated as sanitization or hygienization.

The material can in particular be formed such that in a first step a hot water sanitation with 1° C./min to 2° C./min up to 95° C. is possible and/or in a second step water temperatures of up to 121° C. are possible, in particular with an overpressure of 1.5 bar.

The material can also be formed such that steam can be used up to a pressure of 2 bar for sanitation.

As the material for the wall and/or the discharge pipe of the membrane filtration module, for example, PSU (polyethersulphone), PPSU (polyphenylsulphone) and/or PVC-C (chlorinated polyvinyl chloride) can be used. The membrane filtration module can be formed hygienically on the filtrate side, in particular according to a hygiene standard. The “filtrate side” can here be taken to include any element of the membrane filtration module, which comes into contact with the permeate or filtrate, in particular directly or indirectly.

In particular, the connection between the connection device and the discharge pipe can be formed hygienically. Formed hygienically can in this context mean that the connection is formed according to a hygiene standard. Thus, contamination of the permeate or filtrate in the region of the connection can be prevented or at least reduced.

As the hygiene standard, guidelines can be designated here which have to be fulfilled by the connection to ensure predetermined hygiene standard specifications. The hygiene standard may be, for example, the DIN standard DIN 11864. A hygiene standard can in particular specify geometries or contours for joining elements, types of connection, materials to be used and/or types of sealing, and can recommend the particular advantageous forms which are appropriately easy to clean, so that generally they are formed as follows.

The connection between the connection device and the discharge pipe can be essentially formed without any gap. Since contamination can often collect in gaps, the connection can be formed more hygienically in this way. In the region of the connection between the connection device and the discharge pipe at least one sealing element can also be provided. Also the resulting seal can be formed without any gap. In other words, the connection device and the discharge pipe can be joined together in a planar manner.

The connection device can be formed such that through it a conduit can be connected to the discharge pipe hygienically, in particular according to a hygiene standard. The hygiene standard may be a hygiene standard mentioned above.

The connection device can be detachably, in particular non-destructively detachably, connected to the discharge pipe, in particular bolted to the discharge pipe. Consequently it is possible to separate the connection device from the discharge pipe, for example, in order to service it or to clean it separately.

The discharge pipe can be directly connected to the connection device or through a further element.

For example, the discharge pipe in the region of an end or an opening of the second longitudinal part can comprise a connecting plate joined to the surface shell of the discharge pipe. In this way a secure joint between the discharge pipe and the connection device can be provided. The connecting plate can, for example, surround the discharge pipe in the form of a disc-shaped plate.

In other words the discharge pipe can be joined to the connection device through a connecting plate.

The connecting plate and the discharge pipe can be formed as one part. In other words the discharge pipe can comprise one or a plurality of partial regions with an enlarged external diameter in the region of the second longitudinal part, in particular wherein the connection device in the region of one or a plurality of partial regions is connected to the discharge pipe.

Alternatively, the connecting plate can be bonded or welded to the discharge pipe.

The connecting plate can in particular be a smooth, planar component.

The connection device can be detachably joined to the connecting plate, in particular by bolting.

The discharge pipe can be formed as one part or consist of at least two parts, which are bonded and/or welded together.

The at least two parts can be bonded together, in particular hygienically. Hygienically bonded can here in particular be taken to mean a bond without any gap and almost free of excess.

In particular the first longitudinal part can comprise a first pipe section and the second longitudinal part a second pipe section, wherein the first pipe section and the second pipe section are bonded and/or welded together.

The membrane filtration module can, in addition, comprise a housing, in particular wherein the connection device is joined to the housing. The housing can in particular protect the membrane element from damage. The housing can be for example a stainless steel housing.

In particular the discharge pipe and the membrane element can also be joined to the housing through the connection device.

One end of the discharge pipe, in particular that end, which is located opposite the second longitudinal part, can be closed with a closing element, in particular wherein the closing element is joined to the housing.

The closing element can in particular be joined directly or indirectly to the housing. For example, the closing element can be joined positively locked or non-positively locked to the housing. In particular the closing element can comprise a recess in which a joining element of the housing engages.

The discharge pipe can in particular compromise two ends, wherein the connection device is arranged on the first end and the closing element on the second end. Both ends can in particular be openings of the discharge pipe and comprise the top surface or the base surface of the cylindrically shaped discharge pipe.

The closing element can be supported spring-loaded on the housing. In this way differences in thermal expansion between the housing and discharge pipe can be compensated.

The membrane filtration module can thus comprise a spring element, wherein the closing element is supported spring-loaded on the housing by the spring element. The spring element can in particular be joined to the closing element. The spring element can also put the closing element under tension during the operation of the membrane filtration module, in particular subjecting it to a spring force. In this way secure closure of the discharge pipe can be achieved.

The discharge pipe and/or the connection device can comprise a double groove in the joining region of the discharge pipe to the connection device. In this way a hygienic connection between the discharge pipe and the connection device can be achieved. The double groove can for example be arranged on a connecting plate of the discharge pipe.

In the joining region of the discharge pipe to the connection device a leakage space, in particular with at least one leakage hole, can be provided. In this way a hygienic connection of the discharge pipe to the connection device can be achieved. In particular damage to a sealed side can be found before, for example, unfiltered material can pass to the filtrate side.

The connection device can comprise a top plate or cover plate of a housing of the membrane filtration module. The housing can, in particular during operation of the membrane filtration module, be closed at least partly by the top plate. The double groove, the leakage space and/or the at least one leakage hole can be arranged in particular on the top plate.

The disclosure also provides a filtration system comprising a filtration module described above and a conduit, wherein the conduit is connected to the discharge pipe by the connection device.

In a filtration system of this nature the permeate or the filtrate can be passed out of the membrane filtration module in a hygienic manner.

The membrane filtration module can in particular comprise one or a plurality of the features described above.

The filtration system can in particular be used for the manufacture of sterile water.

The disclosure also provides a beverage processing plant comprising a membrane filtration module described above, in particular a filtration system described above.

The membrane filtration module and/or the filtration system can in particular comprise one or a plurality of the features described above.

The beverage processing system can be for example a beverage filling system.

### BRIEF DESCRIPTION OF THE DRAWINGS

Further features and advantages of the disclosure are explained in the following based on exemplary figures. The following are illustrated:

FIG. 1 parts of an exemplary membrane filtration module;

FIG. 2 an exemplary membrane filtration module;

FIG. 3 part of an exemplary membrane filtration module;

FIG. 4 a further part of an exemplary membrane filtration module;

FIG. 5 further parts of an exemplary membrane filtration module; and

FIG. 6 an example of a cover plate on a housing of an exemplary membrane filtration module.

### DETAILED DESCRIPTION OF THE PREFERRED EMBODIMENT

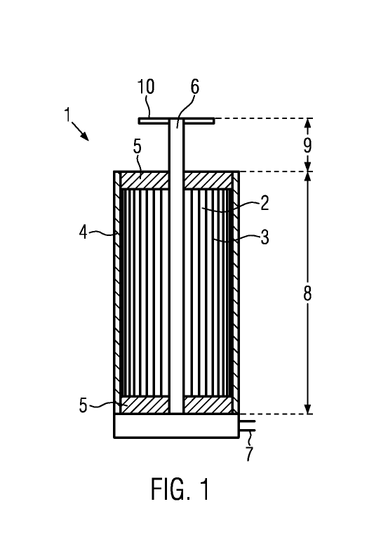

In FIG. 1 parts of an exemplary membrane filtration module 1 are illustrated. In particular FIG. 1 illustrates an example of a membrane element 2, which comprises a plurality of hollow fiber membranes 3. The membrane element 2 is joined to a wall 4 by so-called potting 5 at both ends.

A central discharge pipe 6 is arranged along the longitudinal axis of the exemplary membrane filtration module 1. The filtered liquid (the permeate) can be passed out of the membrane filtration module 1 through this discharge pipe 6. The liquid to be filtered (unfiltered liquid) is passed through an intake 7 into the membrane filtration module 1 and is then introduced into the hollow fiber membrane 3 under pressure. Here, the permeate is pressed through the pores of the hollow fiber membrane 3 and enters into the central discharge pipe 6, from where it can be passed on further. Constituent parts of the liquid to be filtered, which have a greater diameter than the average pore size of the hollow fiber membranes 3, are retained by the hollow fibre membranes 3 and are therefore filtered from the liquid. In particular micro-organisms or germs (bacteria, yeasts) can in this way be filtered from the unfiltered liquid.

The intake 7 can be arranged as shown below the membrane element 2 and/or above the membrane element 2. Also, both intakes can be used simultaneously.

Although in this example hollow fiber membranes 3 are illustrated, in principle flat membranes or spiral wound membranes can also be used. The pore size, in particular the average pore size, can be between 1 μm and 0.001 μm, in particular between 0.2 μm and 0.02 μm. The exemplary membrane filtration module 1 can therefore be used for ultra-filtration.

The membrane element 2 can in particular comprise many hundreds to many thousands of hollow fibres. For example, 30-5000 hollow fibers can be provided. The hollow fibres can be joined together by potting 5 and fixed spatially.

The material for the hollow fiber membrane 3 can comprise or be plastic or ceramics. The material of the exemplary membrane filtration module 1 can in particular be chosen such that the module can be sanitized by hot water. For example, a sump within the module can be reliably sanitized by the hot water.

The discharge pipe 6 in FIG. 1 comprises a first longitudinal part 8, along which the surface shell of the discharge pipe 6 is surrounded by the membrane element 2. In this region the filtrate can also enter the discharge pipe 6.

The discharge pipe 6 also comprises a second longitudinal part 9, which protrudes over the membrane element 2. In other words the length of the discharge pipe 6 along the longitudinal axis of the membrane filtration module 1 is longer by the second part 9 than the corresponding length of the membrane element 2 including potting 5.

At the end or at the opening of the discharge pipe 6 in the second longitudinal part 9 a connecting plate 10 is also arranged. The connecting plate 10 corresponds to a partial region of the second longitudinal part 9, in which the outer diameter of the discharge pipe 6 is enlarged. The connecting plate 10 can be formed as one part with the discharge pipe 6. Alternatively, the connecting plate 10 can also be produced separately and joined to the discharge pipe 6, in particular directly. For example, the connecting plate 10 can be bonded and/or welded.

In FIG. 1 a connection device, which is not illustrated, for connecting an external conduit to the discharge pipe 6 can be joined to the discharge pipe 6, in particular with the connecting plate 10.

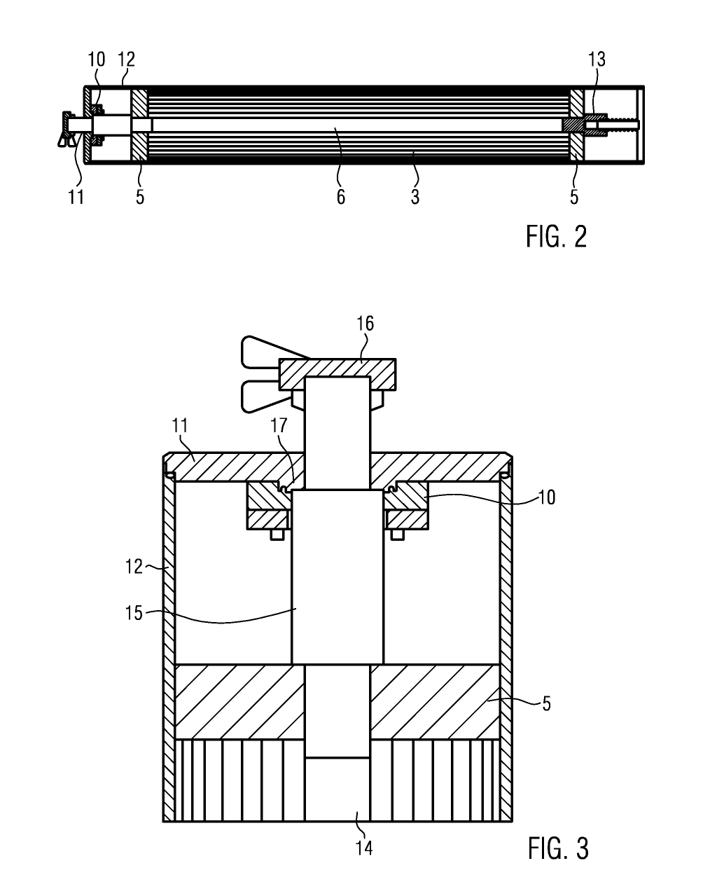

FIG. 2 shows an example of a membrane filtration module. As illustrated in FIG. 1, it comprises a membrane element 2, which is joined by potting 5 to a wall. In addition, the exemplary membrane filtration module comprises a discharge pipe 6 for the permeate. FIG. 2 also illustrates a housing 12, for example in stainless steel, in which the membrane element 2 and the discharge pipe 6 are arranged. A connection device 11 for connecting an external conduit, which is not illustrated, to the discharge pipe 6 is joined to the discharge pipe 6 in the second longitudinal part. The filtrate can for example be passed through the external conduit to a further element of a filtration system or beverage filling system, for example a reservoir.

The connection device 11 also comprises a top plate for the housing 12.

The connection device 11 can be non-destructively detachably joined to the discharge pipe 6, in particular by the connecting plate 10 of the discharge pipe 6. For example, the connection device 11 can be bolted to the connecting plate 10.

The connection between the connection device 11 and the discharge pipe 6 can be formed hygienically, in particular corresponding to a hygiene standard. The hygiene standard can regulate the contours of the connections, for example. In this way a hygienic connection to the discharge pipe 6 is possible and the risk that the filtrate will again be degraded by germs or contamination after filtration can therefore be reduced. The hygiene standard can, for example, correspond to the DIN standard DIN 11864. Alternatively or additionally the connection can also conform to the rules of hygienic design, which are defined by the European Hygienic Engineering and Design Group (EHEDG). Thus, the membrane filtration module 1 can correspond to a hygienic module with aseptic requirements.

The end of the discharge pipe 6 situated opposite the second longitudinal part, that is the end at which the connection device 11 is not arranged, is closed with a closing element 13. The closing element 13 is joined to the housing 12.

FIG. 3 illustrates an extract of an exemplary membrane filtration module, in which in particular the connection device 11 is illustrated. In the example in FIG. 3 the discharge pipe 6 comprises two parts, which are bonded and/or welded together. The first part 14 here comprises in particular the first longitudinal part and a second part 15 comprises the second longitudinal part of the discharge pipe 6. In this way the membrane filtration module can be simply manufactured.

Around the opening or the end of the discharge pipe 6 a partial region is arranged, which comprises an enlarged external diameter. In this way a connecting plate 10 is formed, with which the connection device 11 is detachably joined, in particular bolted. In the joining region 17 the joint is essentially formed without a gap. In this way a particularly hygienic embodiment is possible. Also seals in this region 17 are formed essentially without any gap. The connection device 11 also comprises a joining element 16, with which an external pipe, which is not shown, can be joined.

The joining element 16 can be, for example, clamp connections such as, for example, the joining element “Bio-Connect” from the company Neumo. Alternatively, bolt-on flange joints can also be used.

The connection device 11, in this example, is also formed such that it forms the lid of the housing 12. In other words the connection device 11 comprises an element, which is used as the top plate or cover plate of the housing 12.

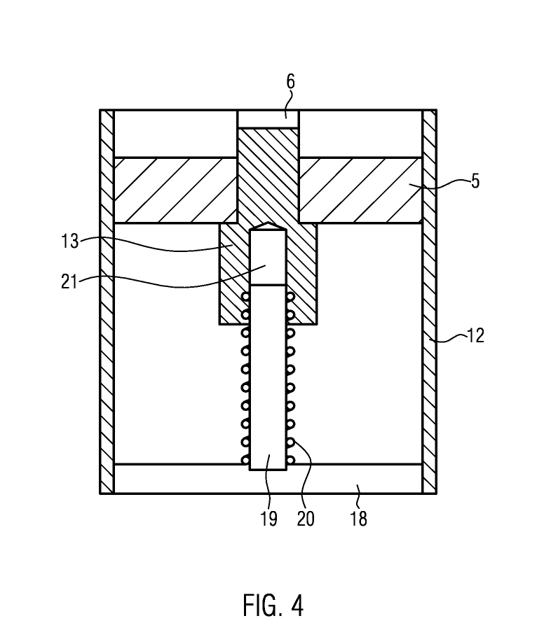

In FIG. 4 a further section of an exemplary membrane filtration module 1 is illustrated, in which in particular a closing element 13 is arranged, which closes one end of the discharge pipe 6. The closing element 13 is joined positively locked to the housing 12 by a joining element 19, in particular a bottom plate 18 of the housing 12.

As a rule this section is arranged at the bottom with standing membrane modules.

The joining element 19 of the housing 12 can here engage, in particular in a positive locking manner, in a recess 21 of the closing element 13. The closing element 13 in this example also comprises a spring element 20, by which it is supported spring-loaded on the housing 12, in particular on the bottom plate 18. For this purpose the spring element 20 surrounds the joining element 19 and a predetermined spring displacement is given by the recess 21. Due to the spring element 20 the closing element 13 can also be subjected to a spring force, which presses the closing element 13 against the membrane element 2, thereby closing the discharge pipe 6. In this way a particularly reliable closure can be achieved.

In this example the spring element 20 is a helical spring. Alternatively however, any other elastic elements can also be provided, which deflect particularly under load and return to their original form when relieved.

Due to the spring-loaded support of the closing element 13, with the sanitization of the membrane filtration module 1 with hot water and/or steam the different longitudinal expansion of the membrane element 2 and the discharge pipe 6 on one side and of the housing 12 (for example a stainless steel housing) on the other side can be compensated. The different longitudinal expansion here occurs in particular along the longitudinal axis of the membrane filtration module.

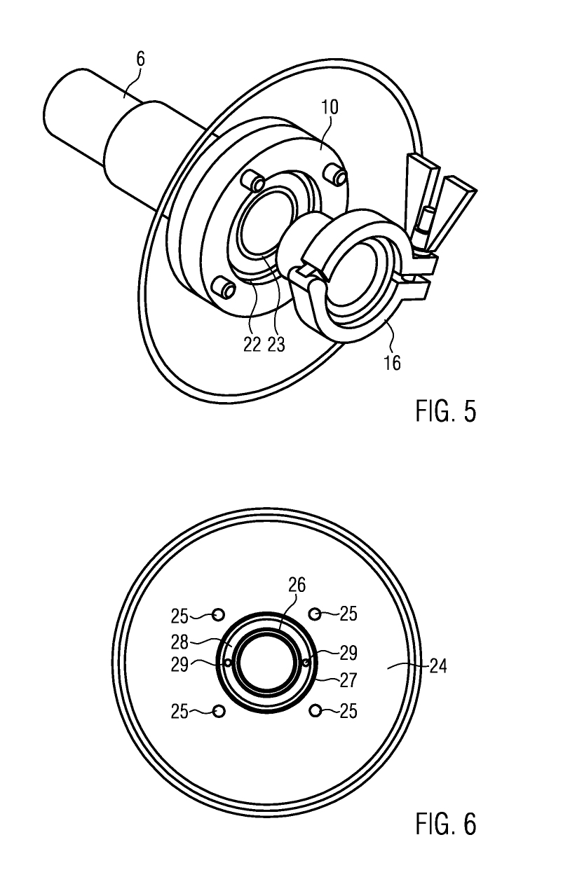

In FIG. 5 further exemplary constituent parts of an exemplary membrane filtration module are illustrated. In particular a second longitudinal part of an exemplary discharge pipe 6 is illustrated, on the end region of which a connecting plate 10 is arranged. In addition, a joining element 16 is also shown, on which an external conduit, which is not illustrated, can be connected. Further parts of the connection device of the membrane filtration module are not illustrated or are only indicated by an ellipse in order to show the joining region between the discharge pipe 6 and the connection device. In this region the discharge pipe 6 comprises in particular two sealing rings 22 and 23, which are arranged concentrically around the symmetrical axis of the discharge pipe 6.

FIG. 6 shows part of an exemplary connection device, which can be joined to the discharge pipe 6 of FIG. 5. In particular a cover plate 24 is illustrated, which also acts as the lid of a housing 12 of an exemplary membrane filtration module. In the cover plate 24 holes 25 have been provided through which the cover plate 24 can be bolted to the connecting plate 10 of a discharge pipe 6 from FIG. 5.

Two grooves 26 and 27 are also illustrated. In these grooves 26, 27 sealing rings 22, 23, as illustrated for example in FIG. 5, engage and therefore facilitate sealing essentially without any gap. A leakage space 28 is provided between the grooves 26, 27. In addition two leakage holes 29 are arranged in the leakage space 28.

It is self-evident that the features mentioned in the previously described embodiments are not restricted to these particular combinations and are possible in any other combinations.

What is claimed is:

1. A membrane filtration module comprising:
a membrane element for filtering a liquid;
a discharge pipe for the permeate or filtrate; and
a connection device for connecting a conduit to the discharge pipe;
wherein the surface shell of the discharge pipe along a first longitudinal part is surrounded by the membrane element,
wherein the discharge pipe in a second longitudinal part protrudes over the membrane element, and
wherein the connection device is connected to the discharge pipe in the region of the second longitudinal part.

2. The membrane filtration module according to claim 1, wherein the joint between the connection device and the discharge pipe is formed hygienically.

3. The membrane filtration module according to claim 1, wherein the joint between the connection device and the discharge pipe is formed essentially without any gap.

4. The membrane filtration module according to claim, wherein the connection device is formed such that with the connection device a conduit can be joined to the discharge pipe hygienically.

5. The membrane filtration module (1) according to claim 1, wherein the connection device is joined detachably to the discharge pipe.

6. The membrane filtration module according to claim 1, wherein the discharge pipe is joined to the connection device by a connecting plate.

7. The membrane filtration module according to claim 1, wherein the discharge pipe is one of formed as one part or consists of at least two parts which are bonded together, welded together, or a combination thereof.

8. The membrane filtration module according claim 1, additionally comprising a housing.

9. The membrane filtration module according to claim 8, wherein one end of the discharge pipe is closed by a closing element.

10. The membrane filtration module according to claim 9, wherein the closing element is supported spring-loaded on the housing.

11. The membrane filtration module according to claim 1, wherein one of the discharge pipe, the connection device, and a combination thereof comprises a double groove in the joining region of the discharge pipe to the connection device.

12. The membrane filtration module according to claim 1, wherein a leakage space is provided in the joining region of the discharge pipe to the connection device.

13. The membrane filtration module according to claim 4, wherein the hygienically joinder is according to a hygiene standard.

14. the membrane filtration module according to claim 5, wherein the connection device is bolted to the discharge pipe.

15. The membrane filtration module according to claim 8, wherein the connection device is joined to the housing.

16. The membrane filtration module according to claim 9, wherein the one end of the discharge pipe is the end located opposite the second longitudinal part.

17. The membrane filtration module according to claim 9, wherein the closing element is joined to the housing.

18. The membrane filtration module according to claim 12, wherein the leakage space comprises at least one leakage hole.
